(19) United States
(12) Patent Application Publication
(10) Pub. No.: US 2025/0369383 A1
(43) Pub. Date: Dec. 4, 2025

(54) DOSER ASSEMBLY WITH SENSOR ASSEMBLY

(71) Applicant: Cummins Emission Solutions, Inc., Columbus, IN (US)

(72) Inventors: Julian Nicolas Aljoscha Raupp, Waldbuettelbrunn (DE); Friedrich Johann Zapf, Karlstadt (DE); Heico Stegmann, Reichenberg (DE); Thomas Kreser, Lohe (DE); Christian Dirk Hintner, Reichenberg (DE); Jens Honeck, Ahorn (DE); Subash Krishna Selvakumar, Marktheidenfeld (DE); Uwe Michael Gadelmeier, Marktheidenfeld (DE)

(73) Assignee: Cummins Emission Solutions, Inc., Columbus, IN (US)

(21) Appl. No.: 18/871,901

(22) PCT Filed: Jun. 6, 2023
(86) PCT No.: PCT/US2023/024619

§ 371 Date: Dec. 5, 2024

Related U.S. Application Data
(60) Provisional application No. 63/350,750, filed on Jun. 9, 2022.

(51) Int. Cl. F01N 3/20; B01D 53/94; G01K 1/08; G01L 19/14

(52) U.S. Cl. CPC F01N 3/208; B01D 53/9431; B01D 53/9495; G01K 1/08; G01L 19/14; B01D 2258/01; F01N 2610/1426; F01N 2610/1433; F01N 2610/1453; F01N 2900/1808; F01N 2900/1811

(57) ABSTRACT

The exhaust of internal combustion engines. such as diesel engines. includes nitrogen oxide (NOx) compounds. It is desirable to reduce NOx emissions to comply with environmental regulations. for example. To reduce NOx emissions, a reductant may be dosed into the exhaust by a closer assembly within an aftertreatment system. The reductant facilitates conversion of a portion of the exhaust into non-NOx emissions, such as nitrogen (N2), carbon dioxide (CO2), and water (H20), thereby reducing NOx emissions. These aftertreatment systems may include a pressure sensor and a temperature sensor that obtain readings from reductant that is'dosed into the exhaust. A doser assembly includes a doser housing and a doser located at least partially within the doser housing. The doser assembly also includes a sensor assembly that includes a pressure sensor assembly having a pressure sensor and a temperature sensor assembly having a temperature sensor.

### CROSS-REFERENCE TO RELATED APPLICATION

This application is a national phase based on PCT Application No. PCT/US2023/024619, filed Jun. 6, 2023, which claims the benefit of and priority to U.S. Provisional Application No. 63/350,750, filed Jun. 9, 2022. The contents of these applications are incorporated herein by reference in their entireties.

### TECHNICAL FIELD

The present disclosure relates generally to a doser assembly with a sensor assembly. The doser assembly is for use in an exhaust gas aftertreatment system for an internal combustion engine.

### BACKGROUND

The exhaust of internal combustion engines, such as diesel engines, includes nitrogen oxide (NOx) compounds. It is desirable to reduce NOₓ emissions to comply with environmental regulations, for example. To reduce NOₓ emissions, a reductant may be dosed into the exhaust by a doser assembly within an aftertreatment system. The reductant facilitates conversion of a portion of the exhaust into non-NOₓ emissions, such as nitrogen (N₂), carbon dioxide (CO₂), and water (H₂O), thereby reducing NOₓ emissions. These aftertreatment systems may include a pressure sensor and a temperature sensor that obtain readings from reductant that is dosed into the exhaust.

### SUMMARY

It can be difficult to mount reductant pressure and temperature sensors in an aftertreatment system in a space-efficient manner while ensuring that accuracy of pressure and temperature readings is maintained. Embodiments of the invention address this problem.

In one embodiment, a doser assembly includes a doser housing and a doser located at least partially within the doser housing. The doser assembly also includes a sensor assembly. The sensor assembly includes a pressure sensor assembly having a pressure sensor and a temperature sensor assembly having a temperature sensor.

In another embodiment, a sensor assembly includes a pressure sensor assembly. The pressure sensor assembly includes a pressure sensor housing having a first attachment portion and a pressure sensor at least partially located in the pressure sensor housing. The sensor assembly also includes a temperature sensor assembly. The temperature sensor assembly includes a temperature sensor housing having a second attachment portion and a temperature sensor at least partially located in the temperature sensor housing. The temperature sensor housing is selectively attachable to and detachable from the pressure sensor housing by attaching the second attachment portion to the first attachment portion.

In another embodiment, a doser assembly includes a doser housing and a doser located at least partially within the doser housing. The doser assembly also includes a sensor assembly that includes a pressure sensor assembly. The pressure sensor assembly includes a pressure sensor housing that includes a first attachment portion, and a pressure sensor that is at least partially located in the pressure sensor housing. The sensor assembly also includes a temperature sensor assembly. The temperature sensor assembly includes a temperature sensor housing including a second attachment portion, and a temperature sensor that is at least partially located in the temperature sensor housing. The temperature sensor housing is selectively attachable to and detachable from the pressure sensor housing by attaching the second attachment portion to the first attachment portion.

### BRIEF DESCRIPTION OF THE DRAWINGS

The disclosure will become more fully understood from the following detailed description, taken in conjunction with the accompanying Figures, wherein like reference numerals refer to like elements unless otherwise indicated, in which:

FIG. 1 is a block schematic diagram of an example exhaust gas aftertreatment system;

FIG. 2 is a perspective view of a doser assembly including a sensor assembly, according to an embodiment;

FIG. 3 is an exploded view of the doser assembly of FIG. 2 including a cover, according to an embodiment;

FIG. 4 is a perspective view of the doser assembly of FIG. 2 excluding a temperature sensor assembly, according to an embodiment;

FIGS. 5 and 6 are perspective views of the sensor assembly of FIG. 2, according to an embodiment;

FIG. 7 is a perspective view of a portion of the sensor assembly of FIGS. 5 and 6, according to an embodiment;

FIG. 8 is an exploded view of the sensor assembly of FIGS. 5 and 6 including a temperature sensor assembly, according to an embodiment;

FIG. 9 is a perspective view of the temperature sensor assembly of FIG. 8, according to an embodiment;

FIG. 10 is a perspective view of another sensor assembly including a pressure sensor assembly and a pressure sensor housing, according to an embodiment;

FIG. 11 is a perspective view of the pressure sensor housing of FIG. 10, according to an embodiment;

FIG. 12 is a bottom view of the pressure sensor assembly of FIG. 10, according to an embodiment;

FIG. 13 is a cross-sectional view of the doser assembly of FIG. 2 taken along line 11-11 in FIG. 2, according to an embodiment;

FIG. 14 is a view of Detail A in FIG. 13, according to an embodiment;

FIGS. 15 and 16 are top views of the doser assembly of FIG. 2, according to an embodiment;

FIG. 17 is a top view of the doser assembly of FIG. 2 with a partially transparent cover, according to an embodiment;

FIG. 18 is a cross-sectional view of the doser assembly of FIG. 2 taken along line 18-18 in FIG. 17, according to an embodiment; and

FIG. 19 is a bottom view of the cover of FIG. 3, according to an embodiment.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION

Following below are more detailed descriptions of various concepts related to, and implementations of, methods, apparatuses, and for providing a doser assembly with a sensor assembly for an exhaust gas aftertreatment system of an internal combustion engine. The various concepts introduced above and discussed in greater detail below may be implemented in any of a number of ways, as the described concepts are not limited to any particular manner of implementation. Examples of specific implementations and applications are provided primarily for illustrative purposes.

### I. Overview

Internal combustion engines (e.g., diesel internal combustion engines, etc.) produce exhaust gas that is often treated by a doser assembly within an exhaust gas aftertreatment system. The doser assembly typically treats exhaust gas using a reductant released from the doser assembly by an injector of a doser. The reductant is adsorbed by a catalyst. The adsorbed reductant in the catalyst functions to reduce NOₓ in the exhaust gas. The doser assembly is mounted on a component of the exhaust gas aftertreatment system. For example, the doser assembly may be mounted on a decomposition reactor, an exhaust conduit, or other similar component of the exhaust gas aftertreatment system.

Within the doser assembly, the reductant is transported through a doser housing. The doser housing includes a reductant inlet passage and a reductant return passage. The doser assembly may include a pressure sensor and a temperature sensor that obtain readings from the reductant. Typically, the pressure sensor is configured to be partially within the reductant inlet passage and the temperature sensor is configured to be partially within the reductant return passage. In other instances, the temperature sensor is configured to be within the doser assembly but outside of the doser housing. However, these combinations of a pressure measurement by the pressure sensor within the reductant inlet passage and a temperature measurement by a temperature sensor within the reductant return passage or the doser assembly are very different from an actual pressure and an actual temperature near the injector partially due to the pressure measurement and the temperature measurement being taken from different locations. This is not ideal for dosing when determining how much of a reductant to inject in the exhaust gas as a reductant injection amount is dependent on accuracy of and consistency between the pressure measurement and the temperature measurement. Additionally, a distance between the pressure sensor and temperature sensor in these configurations may require the use of several electrical connectors, which can increase cost and manufacturing complexity, which are undesirable.

Implementations herein are related to a doser assembly that has a sensor assembly incorporating features that reduce the need for several electrical connectors, simplify assembly, and reduce cost compared to other doser assemblies. For example, the sensor assembly described herein includes both a pressure sensor assembly that has a pressure sensor and a temperature sensor assembly that has a temperature sensor. By incorporating both the pressure sensor and the temperature sensor into the same assembly, the doser assembly described herein is capable of utilizing less electrical connectors than other doser assemblies and is capable of being assembled more easily, and therefore less expensively, than other doser assemblies.

The sensor assembly described herein also includes a pressure sensor housing with a first attachment portion, and a temperature sensor housing with a second attachment portion. The temperature sensor housing is attachable to and detachable from the pressure sensor housing by attaching the second attachment portion to the first attachment portion, thereby incorporating both the pressure sensor and the temperature sensor into the same assembly. In order to efficiently extract readings (e.g., measurements, etc.) from the pressure sensor and the temperature sensor and to minimize a number of electrical connectors within the sensor assembly, the pressure sensor housing includes a first electrical connector that is configured to receive an electrical connection from both the pressure sensor and the temperature sensor.

Additionally, the doser assembly described herein further includes a doser housing incorporating features to improve determining a reductant injection amount into an exhaust gas. The doser housing includes a reductant inlet passage and a reductant return passage. Rather than configuring the pressure sensor and the temperature sensor in different locations within the doser housing, the doser assembly described herein configures both the pressure sensor and the temperature sensor to be at least partially within the reductant inlet passage or the reductant return passage together. This results in improved accuracy of and consistency between a pressure measurement by the pressure sensor and a temperature measurement by the temperature sensor, thereby improving accuracy of determining the reductant injection amount into the exhaust gas and reducing the distance between the pressure sensor and the temperature sensor.

### II. Overview of Exhaust Gas Aftertreatment System

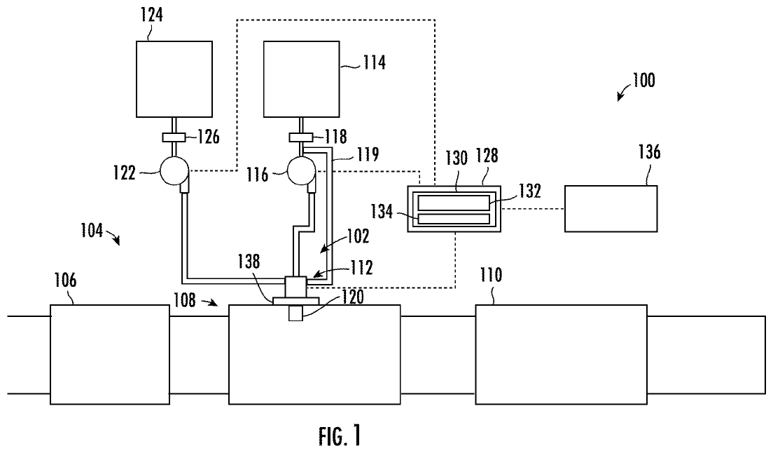

FIG. 1 depicts an exhaust gas aftertreatment system 100 having an example reductant delivery system 102 for an exhaust conduit system 104. The exhaust gas aftertreatment system 100 includes the reductant delivery system 102, a particulate filter (e.g., a diesel particulate filter (DPF)) 106, a decomposition chamber 108 (e.g., reactor, reactor pipe, etc.), and an SCR catalyst 110.

The particulate filter 106 is configured to (e.g., structured to, able to, etc.) remove particulate matter, such as soot, from exhaust gas flowing in the exhaust conduit system 104. The particulate filter 106 includes an inlet, where the exhaust gas is received, and an outlet, where the exhaust gas exits after having particulate matter substantially filtered from the exhaust gas and/or converting the particulate matter into carbon dioxide. In some implementations, the particulate filter 106 may be omitted.

The decomposition chamber 108 is configured to convert a reductant into ammonia. The reductant may be, for example, urea, diesel exhaust fluid (DEF), Adblue®, a urea water solution (UWS), an aqueous urea solution (e.g., AUS32, etc.), and/or other similar fluids. The decomposition chamber 108 includes an inlet in fluid communication with the particulate filter 106 to receive the exhaust gas containing NOₓ emissions and an outlet for the exhaust gas, NOₓ emissions, ammonia, and/or reductant to flow to the SCR catalyst 110.

The reductant delivery system 102 includes a doser assembly 112 (e.g., dosing module, etc.) configured to dose the reductant into the decomposition chamber 108 (e.g., via an injector). The doser assembly 112 is mounted to the decomposition chamber 108 such that the doser assembly 112 may dose the reductant into the exhaust gas flowing through the exhaust conduit system 104. The doser assembly 112 may include an insulator (e.g., vibrational insulator, thermal insulator, etc.) interposed between a portion of the doser assembly 112 and a portion of the decomposition chamber 108 on which the doser assembly 112 is mounted. The insulator may mitigate transfer of vibrations and/or heat from the decomposition chamber 108 to the doser assembly 112.

The doser assembly 112 is fluidly coupled to (e.g., fluidly configured to communicate with, etc.) a reductant source 114. The reductant source 114 may include multiple reductant sources 114. The reductant source 114 may be, for example, a diesel exhaust fluid tank containing Adblue®. A reductant pump 116 (e.g., supply unit, etc.) is used to pressurize the reductant from the reductant source 114 for delivery to the doser assembly 112. In some embodiments, the reductant pump 116 is pressure-controlled (e.g., controlled to obtain a target pressure, etc.). The reductant pump 116 includes a reductant filter 118. The reductant filter 118 filters (e.g., strains, etc.) the reductant prior to the reductant being provided to internal components (e.g., pistons, vanes, etc.) of the reductant pump 116. For example, the reductant filter 118 may inhibit or prevent the transmission of solids (e.g., solidified reductant, contaminants, etc.) to the internal components of the reductant pump 116. In this way, the reductant filter 118 may facilitate prolonged desirable operation of the reductant pump 116. In some embodiments, the reductant pump 116 is coupled (e.g., fastened, attached, affixed, welded, etc.) to a chassis of a vehicle associated with the exhaust gas aftertreatment system 100. In some embodiments, the exhaust gas aftertreatment system 100 includes a recirculation conduit 119 coupled to the doser assembly 112 and a conduit extending from the reductant filter 118 to the reductant pump 116 (e.g., downstream of the reductant filter 118 and upstream of the reductant pump 116). The recirculation conduit 119 provides a portion of the fluid located in the doser assembly 112 to the reductant pump 116 so that the portion of the fluid can be recirculated to the doser assembly 112. In other embodiments, the exhaust gas aftertreatment system 100 does not include the recirculation conduit 119, such that the fluid located in the doser assembly 112 is not recirculated to the doser assembly 112.

The doser assembly 112 includes at least one injector 120. Each injector 120 is configured to dose the reductant into the exhaust gas (e.g., within the decomposition chamber 108, etc.). In some embodiments, the reductant delivery system 102 also includes an air pump 122. In these embodiments, the air pump 122 draws air from an air source 124 (e.g., air intake, etc.) and through an air filter 126 disposed upstream of the air pump 122. Additionally, the air pump 122 provides the air to the doser assembly 112 via a conduit. In these embodiments, the doser assembly 112 is configured to mix the air and the reductant into an air-reductant mixture and to provide the air-reductant mixture into the decomposition chamber 108. In other embodiments, the reductant delivery system 102 does not include the air pump 122 or the air source 124. In such embodiments, the doser assembly 112 is not configured to mix the reductant with air.

The doser assembly 112 and the reductant pump 116 are also electrically or communicatively coupled to a reductant delivery system controller 128. The reductant delivery system controller 128 controls the doser assembly 112 to dose the reductant into the decomposition chamber 108. The reductant delivery system controller 128 may also control the reductant pump 116.

The reductant delivery system controller 128 includes a processing circuit 130. The processing circuit 130 includes a processor 132 and a memory 134. The processor 132 may include a microprocessor, an application-specific integrated circuit (ASIC), a field-programmable gate array (FPGA), etc., or combinations thereof. The memory 134 may include, but is not limited to, electronic, optical, magnetic, or any other storage or transmission device capable of providing a processor, ASIC, FPGA, etc. with program instructions. This memory 134 may include a memory chip, Electrically Erasable Programmable Read-Only Memory (EEPROM), Erasable Programmable Read Only Memory (EPROM), flash memory, or any other suitable memory from which the reductant delivery system controller 128 can read instructions. The instructions may include code from any suitable programming language. The memory 134 may include various modules that include instructions which are configured to be implemented by the processor 132.

In various embodiments, the reductant delivery system controller 128 is configured to communicate with a central controller 136 (e.g., engine control unit (ECU), engine control module (ECM), etc.) of an internal combustion engine having the exhaust gas aftertreatment system 100. In some embodiments, the central controller 136 and the reductant delivery system controller 128 are integrated into a single controller.

In some embodiments, the central controller 136 is communicable with a display device (e.g., screen, monitor, touch screen, heads up display (HUD), indicator light, etc.). The display device may be configured to change state in response to receiving information from the central controller 136. For example, the display device may be configured to change between a static state (e.g., displaying a green light, displaying a “SYSTEM OK” message, etc.) and an alarm state (e.g., displaying a blinking red light, displaying a “SERVICE NEEDED” message, etc.) based on a communication from the central controller 136. By changing state, the display device may provide an indication to a user (e.g., operator, etc.) of a status (e.g., operation, in need of service, etc.) of the reductant delivery system 102.

The decomposition chamber 108 is located upstream of the SCR catalyst 110. As a result, the reductant is injected upstream of the SCR catalyst 110 such that the SCR catalyst 110 receives a mixture of the reductant and exhaust gas. The reductant droplets undergo the processes of evaporation, thermolysis, and hydrolysis to form non-NOₓ emissions (e.g., gaseous ammonia, etc.) within the exhaust conduit system 104.

The SCR catalyst 110 includes an inlet in fluid communication with the decomposition chamber 108 from which exhaust gas and reductant are received and an outlet in fluid communication with an end of the exhaust conduit system 104.

The exhaust gas aftertreatment system 100 may further include an oxidation catalyst (e.g., a diesel oxidation catalyst (DOC)) in fluid communication with the exhaust conduit system 104 (e.g., downstream of the SCR catalyst 110 or upstream of the particulate filter 106) to oxidize hydrocarbons and carbon monoxide in the exhaust gas.

In some implementations, the particulate filter 106 may be positioned downstream of the decomposition chamber 108. For instance, the particulate filter 106 and the SCR catalyst 110 may be combined into a single unit. In some implementations, the doser assembly 112 may instead be positioned downstream of a turbocharger or upstream of a turbocharger.

The exhaust gas aftertreatment system 100 also includes a doser mounting bracket 138 (e.g., mounting bracket, coupler, plate, etc.). The doser mounting bracket 138 couples the doser assembly 112 to a component of the exhaust gas aftertreatment system 100. The doser mounting bracket 138 is configured to mitigate the transfer of heat from the exhaust gas passing through the exhaust conduit system 104 to the doser assembly 112. In this way, the doser assembly 112 is capable of operating more efficiently and desirably than other doser assemblies which are not able to mitigate the transfer of heat. Additionally, the doser mounting bracket 138 is configured to aid in reliable installation of the doser assembly 112. This may decrease manufacturing costs associated with the exhaust gas aftertreatment system 100 and ensure repeated desirable installation of the doser assembly 112.

In various embodiments, the doser mounting bracket 138 couples the doser assembly 112 to the decomposition chamber 108. In some embodiments, the doser mounting bracket 138 couples the doser assembly 112 to an exhaust conduit of the exhaust conduit system 104. For example, the doser mounting bracket 138 may couple the doser assembly 112 to an exhaust conduit of the exhaust conduit system 104 that is upstream of the decomposition chamber 108 or to an exhaust conduit of the exhaust conduit system 104 that is downstream of the decomposition chamber 108. In some embodiments, the doser mounting bracket 138 couples the doser assembly 112 to the particulate filter 106 and/or the SCR catalyst 110. The location of the doser mounting bracket 138 may be varied depending on the application of the exhaust gas aftertreatment system 100. For example, in some exhaust gas aftertreatment systems 100, the doser mounting bracket 138 may be located further upstream than in other exhaust gas aftertreatment systems 100. Furthermore, some exhaust gas aftertreatment systems 100 may include multiple doser assemblies 112 and therefore may include multiple doser mounting brackets 138.

### III. Overview of Example Doser Assembly

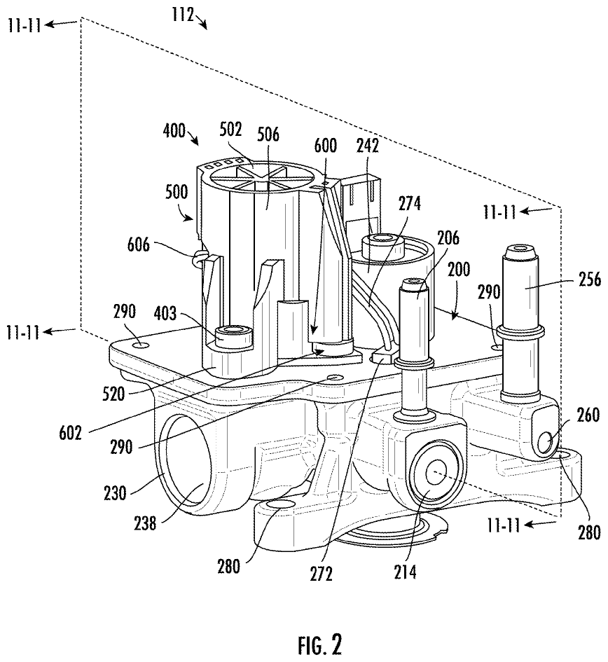

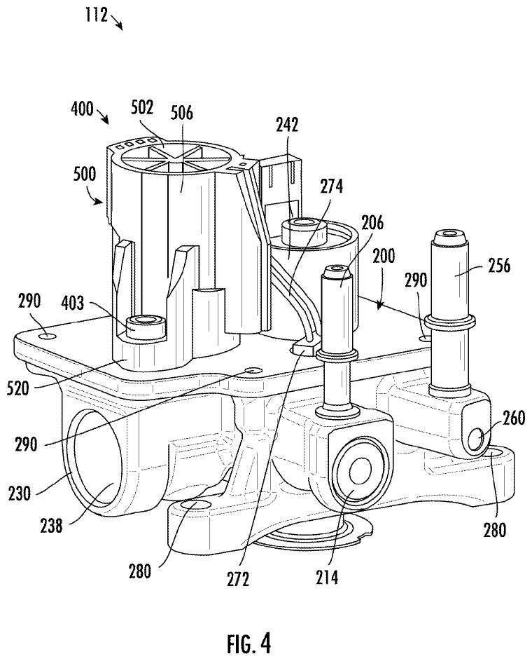

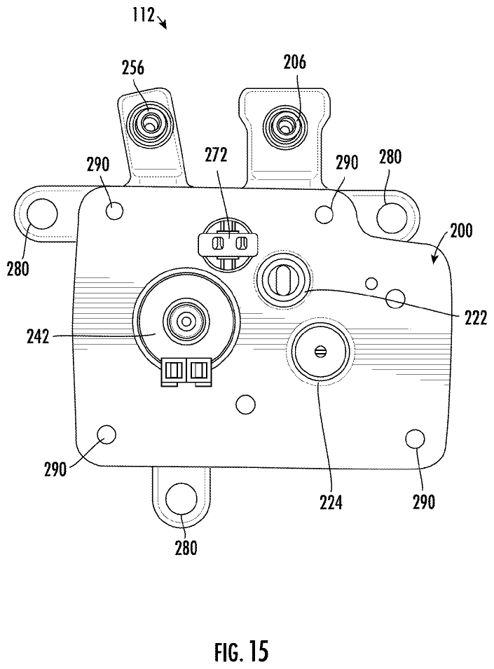

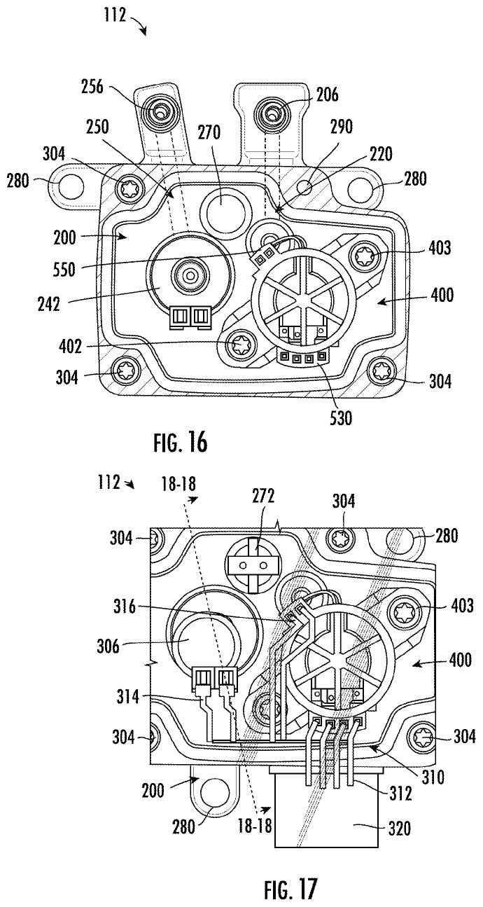

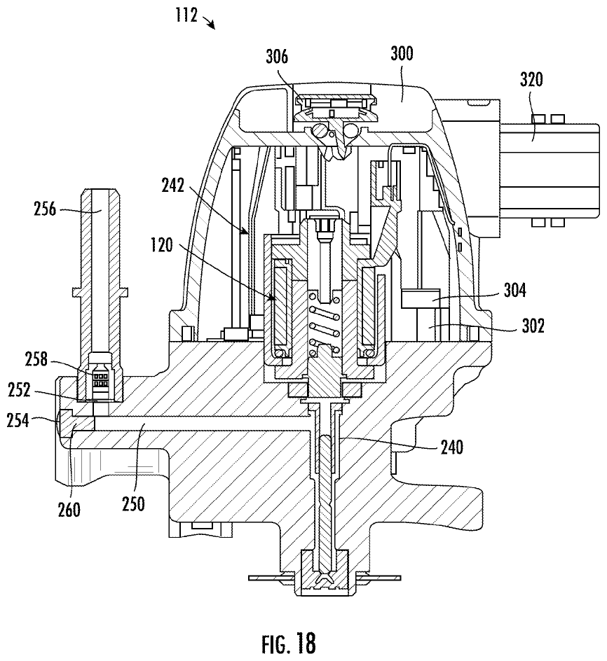

FIGS. 2-4 and 13-18 illustrate the doser assembly 112 according to various embodiments. The doser assembly 112 includes a doser housing 200 (e.g., body, frame, etc.). The doser housing 200 is configured to be coupled to the decomposition chamber 108, and contains components of the doser assembly 112.

The doser housing 200 includes an inlet port 202. The inlet port 202 is configured to be coupled to a conduit that provides reductant (e.g., from the reductant pump 116, etc.) and air (e.g., from the air pump 122). In embodiments where the air pump 122 is not included, the inlet port 202 receives only reductant via the conduit. The doser assembly 112 also includes an inlet tube 206 (e.g., pipe, etc.). The inlet tube 206 is at least partially received within the inlet port 202, such that the inlet tube 206 allows for a hydraulic connection (e.g., via hoses, pipes, etc.) between (i) the reductant pump 116 and the inlet port 202 and (ii) the air pump 122 and the inlet port 202. In embodiments where the air pump 122 is not included, the inlet tube 206 allows for a hydraulic connection between only the reductant pump 116 and the inlet port 202. In other embodiments, the inlet port 202 is configured to fluidly couple to the reductant pump 116 or the reductant pump 116 and the air pump 122 directly via hydraulic connections, without the inlet tube 206.

The doser housing 200 also includes a filter chamber 204. The filter chamber 204 is fluidly coupled to the inlet port 202. The filter chamber 204 is configured to at least partially receive a doser filter 208 (e.g., filter screen, filter cartridge, etc.). The doser filter 208 filters (e.g., strains, etc.) the reductant from the reductant pump 116 and the air from the air pump 122. In embodiments where the air pump 122 is not included, the doser filter 208 only filters the reductant from the reductant pump 116. In other embodiments, the doser assembly 112 does not include the doser filter 208 and relies on the filtration of the air through the air filter 126 and/or the reductant through the reductant filter 118. The doser filter 208 includes a filter screen 210 (e.g., mesh, etc.). The filter screen 210 facilitates filtering of the reductant from the reductant pump 116. The doser assembly 112 includes a filter seal member 212. In some embodiments, the filter screen 210 and the filter seal member 212 are combined. The doser assembly 112 further includes a filter fastener 214 (e.g., screw, bolt, etc.). The filter fastener 214 is configured to be at least partially received within the doser filter 208 such that the filter screen 210 extends (e.g., projects, protrudes, etc.) around the filter fastener 214 and the filter seal member 212 is positioned around the filter fastener 214. The filter seal member 212 provides for a seal (e.g., an air tight seal, etc.) between the filter fastener 214 and the doser housing 200 (e.g., around the filter chamber 204). When accessing the doser filter 208 or accessing components of the doser filter 208 (e.g., filter screen 210) and/or replacement of the filter seal member 212 is desired, the filter fastener 214 can be removed (e.g., completely loosened, taken out, etc.) and the components can be accessed for maintenance or replacement. It may be desirable to replace the doser filter 208 with another doser filter 208 having a different filter screen 210 with a different filtration efficiency. In this way, a user can reconfigure the doser assembly 112 such that the doser assembly 112 is tailored for a target application. In other embodiments, the doser filter 208 does not include the filter fastener 214 such that the doser filter 208 secures to the filter chamber 204 through a snap-fit (e.g., friction, etc.) between the doser filter 208 and the filter chamber 204.

The doser housing 200 also includes a reductant inlet passage 220 (e.g., inlet port, etc.). The reductant inlet passage 220 is fluidly coupled to the filter chamber 204. The reductant inlet passage 220 receives fluid (e.g., reductant, air, reductant and air mixture, etc.) from the doser filter 208 and guides the filtered fluid within the doser housing 200. In other embodiments, the reductant inlet passage 220 is configured to be a part of the filter chamber 204 or the inlet port 202.

The doser housing 200 also includes a frost compensation chamber 230. The frost compensation chamber 230 is fluidly coupled to the reductant inlet passage 220. The doser assembly 112 also includes a frost compensator 232. The frost compensator 232 is configured to be at least partially received within the frost compensation chamber 230. The frost compensator 232 compensates for an expansion of the fluid, when the fluid reaches a temperature below its freezing point. This prevents the fluid from damaging the doser housing 200 when it expands. The frost compensator 232 includes a frost compensation membrane 234. The frost compensator 232 includes a foam insert 236. The foam insert 236 is configured to be received within the frost compensation membrane 234. The foam insert 236 facilitates passage of the reductant within the frost compensation chamber 230 and is configured to be compressed by expansion of the reductant within the frost compensation chamber 230. The frost compensator 232 includes a frost compensation fastener 238 (e.g., plug, screw, bolt, etc.). The frost compensation fastener 238 is configured to be at least partially received within the frost compensation chamber 230. The frost compensation fastener 238 is configured to cooperate with the doser housing 200 to contain the frost compensation membrane 234 and the foam insert 236 in the frost compensation chamber 230. When accessing the frost compensation membrane 234 and/or the foam insert 236 is desired, the frost compensation fastener 238 can be removed and the frost compensation membrane 234 and/or the foam insert 236 can be accessed for maintenance or replacement. In some embodiments, the frost compensation fastener 238 is welded to the frost compensation chamber 230. In some embodiments, the foam insert 236 is made from silicone.

The doser housing 200 also includes a doser chamber 240. The doser chamber 240 is fluidly coupled to the frost compensation chamber 230. The doser assembly 112 includes a doser 242. The doser 242 is configured to be at least partially received within the doser chamber 240. The injector 120 is housed within the doser 242. The doser 242 operates (e.g., controls, manipulates, etc.) the injector 120 according to instructions received from the reductant delivery system controller 128. The doser 242 operates the injector 120 by setting it to either (i) an open position that allows for fluid to exit the doser assembly 112 or (ii) a closed position that prevents fluid from exiting the doser assembly 112.

The doser housing 200 includes a reductant return passage 250 (e.g., outlet port, etc.). The reductant return passage 250 is fluidly coupled to the doser chamber 240. The reductant return passage 250 receives any fluid amount that enters the doser housing 200 through the inlet port 202 but is not released from the doser assembly 112 through the doser chamber 240 via the injector 120. The reductant return passage 250 allows for fluid that did not leave the doser housing 200 via the injector 120 to be reintroduced to the doser housing 200 via the recirculation conduit 119.

The doser housing 200 also includes a first outlet port 252. The first outlet port 252 is fluidly coupled to the reductant return passage 250. The first outlet port 252 is configured to release fluid from the reductant return passage 250 to an outside of the doser housing 200. The doser assembly 112 includes an outlet tube fastener 258 (e.g., screw, bolt, etc.). The outlet tube fastener 258 is configured to be at least partially received within the first outlet port 252. The doser assembly 112 includes an outlet tube 256 (e.g., pipe, etc.). The outlet tube 256 is configured to at least partially receive the outlet tube fastener 258. The outlet tube 256 allows for a hydraulic connection between the reductant return passage 250 and the recirculation conduit 119. The doser housing 200 includes a second outlet port 254. The second outlet port 254 is fluidly coupled to the reductant return passage 250. The doser assembly 112 includes an outlet fastener 260 (e.g., plug, screw, bolt, etc.). The outlet fastener 260 is configured to be at least partially received within the second outlet port 254. The outlet fastener 260 is configured to prevent fluid from leaving the doser housing 200 from the reductant return passage 250 through the second outlet port 254. For example, the outlet fastener 260 may be sealed to the doser housing 200 along an entire perimeter (e.g., 360 degrees, etc.) of the outlet fastener 260. In some embodiments, the outlet fastener 260 is welded to the second outlet port 254. In other embodiments, the doser housing 200 does not include the second outlet port 254.

The doser assembly 112 further includes a sensor assembly 400. The sensor assembly 400 is configured to be at least partially received within the doser housing 200. As is explained in more detail herein, the sensor assembly 400 contains sensors that provide information regarding desirable measurements (e.g., pressure, temperature, etc.) taken within the doser housing 200 to the reductant delivery system controller 128. In this way, the sensor assembly 400 enables the reductant delivery system controller 128 to desirably control the reductant delivery system 102.

The sensor assembly 400 includes a pressure sensor assembly 500. The pressure sensor assembly 500 is capable of facilitating a pressure measurement of the fluid within the doser housing 200. The pressure sensor assembly 500 includes a pressure sensor housing 502. The pressure sensor assembly 500 further includes a pressure sensor 228. The pressure sensor 228 is configured to be at least partially located in the pressure sensor housing 502. The pressure sensor 228 facilitates pressure measurements of the fluid within the doser housing 200.

The doser housing 200 includes a pressure sensor chamber 224. The pressure sensor chamber 224 is fluidly coupled to the reductant inlet passage 220. The pressure sensor chamber 224 is configured to at least partially receive the pressure sensor 228. The pressure sensor 228 facilitates pressure measurements of the fluid in the reductant inlet passage 220. In other embodiments, the pressure sensor chamber 224 is fluidly coupled to the reductant return passage 250, such that the pressure sensor 228 facilitates pressure measurements of the fluid in the reductant return passage 250.

The sensor assembly 400 also includes a temperature sensor assembly 600. The temperature sensor assembly 600 is capable of facilitating a temperature measurement of the fluid within the doser housing 200. The temperature sensor assembly 600 includes a temperature sensor housing 602. The temperature sensor assembly 600 further includes a temperature sensor 226. The temperature sensor 226 is configured to be at least partially located in the temperature sensor housing 602. The temperature sensor 226 facilitates temperature measurements of the fluid within the doser housing 200.

The doser housing 200 includes a temperature sensor chamber 222. The temperature sensor chamber 222 is fluidly coupled to the reductant inlet passage 220. The temperature sensor chamber 222 is configured to at least partially receive the temperature sensor 226. The temperature sensor 226 facilitates temperature measurements of the fluid in the reductant inlet passage 220. In other embodiments, the temperature sensor chamber 222 is fluidly coupled to the reductant return passage 250, such that the temperature sensor 226 facilitates temperature measurements of the fluid in the reductant return passage 250.

The doser housing 200 further includes a heater chamber 270. The heater chamber 270 is adjacent to the filter chamber 204, the reductant inlet passage 220, the frost compensation chamber 230, the doser chamber 240, and the reductant return passage 250. The heater chamber 270 is not fluidly coupled to any passages or bores of the doser housing 200 (e.g., the inlet port 202, the filter chamber 204, the reductant inlet passage 220, the frost compensation chamber 230, the doser chamber 240, the reductant return passage 250, the temperature sensor chamber 222, the pressure sensor chamber 224, etc.), such that the heater chamber 270 is isolated from the fluid within the doser housing 200.

The doser assembly 112 also includes a heater 272 (e.g., electrical heater, etc.). The heater chamber 270 is configured to receive at least a portion of the heater 272. The heater 272 is in contact with an inside wall of the heater chamber 270 such that when the heater 272 is turned on (e.g., heating, etc.), the heater 272 will conductively heat the doser housing 200, thereby increasing the temperature of the reductant inside of the doser housing 200. An increase in temperature of the reductant can help the reductant better evaporate when injected into the decomposition chamber 108 via the injector 120. In other embodiments, the heater 272 can be coupled to the outside of the doser housing 200 adjacent to the inlet port 202.

The doser housing 200 further includes one or more attachment bores 280. The attachment bores 280 may be disposed along edges of the doser housing 200. The attachment bores 280 are configured to receive attachment fasteners that couple the doser housing 200 to the doser mounting bracket 138, thereby coupling the doser assembly 112 to the doser mounting bracket 138.

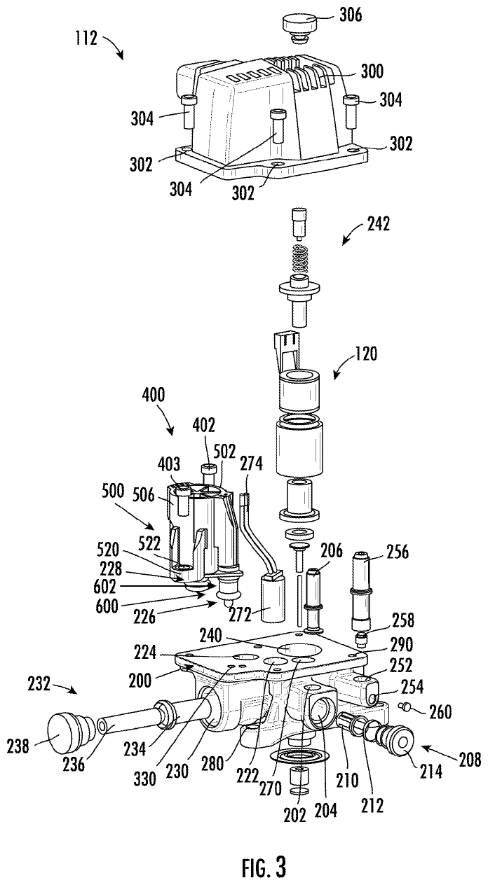

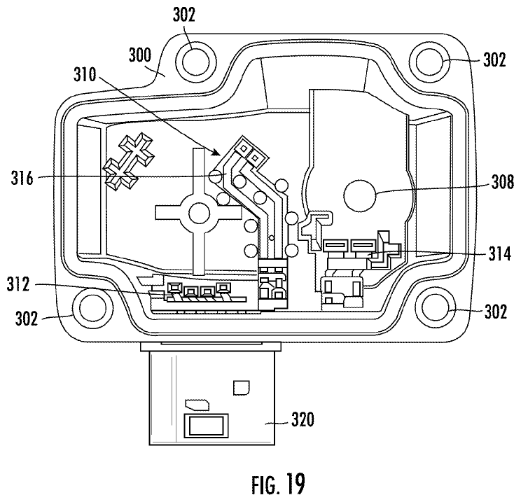

The doser housing 200 further includes cover bores 290. The cover bores 290 may be disposed along edges of the doser housing 200. As shown in FIGS. 3 and 19, the doser assembly 112 includes a cover 300. The cover 300 is configured to couple to a top surface of the doser housing 200, thereby covering and protecting some components of the doser assembly 112. The cover 300 includes cover apertures 302. Each of the cover apertures 302 is aligned with one of the cover bores 290. The cover apertures 302 may be disposed along edges of the cover 300. The doser assembly 112 includes cover fasteners 304. The cover fasteners 304 couple the cover 300 to the top surface of the doser housing 200 via the cover apertures 302 and the cover bores 290.

The cover 300 includes an opening 308. The opening 308 is disposed at a top surface of the cover 300. The opening 308 provides a quick-access to the doser 242 without removal of the cover 300, which might be desirable for maintenance, checkups, etc. For example, the opening 308 may be configured to receive a tool (e.g., screwdriver, hex key, etc.) for adjustment of the doser 242 without removal of the cover 300. In other embodiments, the cover 300 does not include the opening 308 such that access to the doser 242 requires the removal (e.g., uncoupling, etc.) of the cover 300 from the doser housing 200.

The cover 300 also includes a cap 306. The cap 306 is configured to couple to the opening 308. When the cap 306 is coupled to the opening 308, the cap 306 prevents materials from an outside of the doser assembly 112 (e.g., fluids, particulate matter, etc.) from entering the doser assembly 112 through the opening 308.

The cover 300 also includes one or more electrical connectors 310. The electrical connectors 310 are coupled to the inside of the cover 300. The cover 300 further includes an electrical customer interface 320 (e.g., connector, etc.). The electrical customer interface 320 is coupled to an outside of the cover 300. The electrical customer interface 320 is coupled to the electrical connectors 310. The electrical customer interface 320 is also coupled, via an electronic connector, to the reductant delivery system controller 128. When the cover 300 is coupled to the doser housing 200, the electrical connectors 310 are configured to couple to some components of the doser assembly 112 to facilitate (i) transfer of information from/to some components of the doser assembly 112 to/from the reductant delivery system controller 128 via the electrical customer interface 320 and/or (ii) electrical supply from the reductant delivery system controller 128 to some components of the doser assembly 112 via the electrical customer interface 320.

The electrical connectors 310 include sensor connectors 312. The sensor connectors 312 are configured to provide an electrical connection (e.g., for information transfer, electrical power, etc.) between (i) the temperature sensor 226 and the electrical customer interface 320 and (ii) the pressure sensor 228 and the electrical customer interface 320. The electrical connectors 310 also include doser connectors 314. The doser connectors 314 are configured to provide an electrical connection between the doser 242 and the electrical customer interface 320. The electrical connectors 310 also include heater connectors 316. The heater connectors 316 are configured to provide an electrical connection between the heater 272 and the electrical customer interface 320. In some embodiments, the reductant delivery system controller 128 operates some components of the doser assembly 112 via the electrical customer interface 320.

### IV. Overview of Example Sensor Assemblies

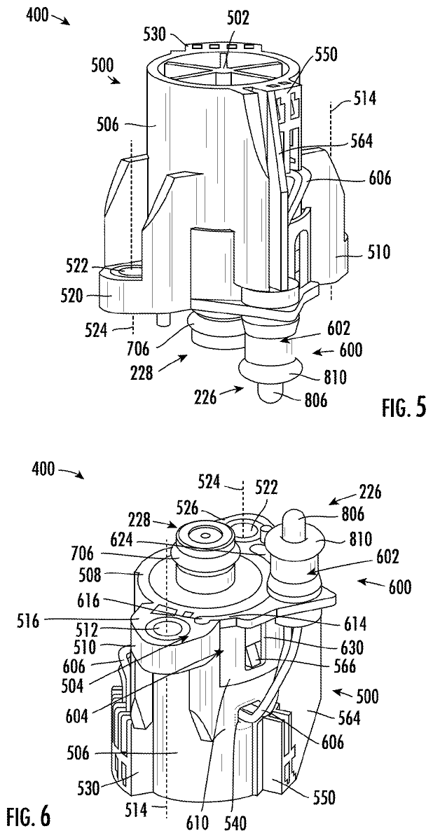

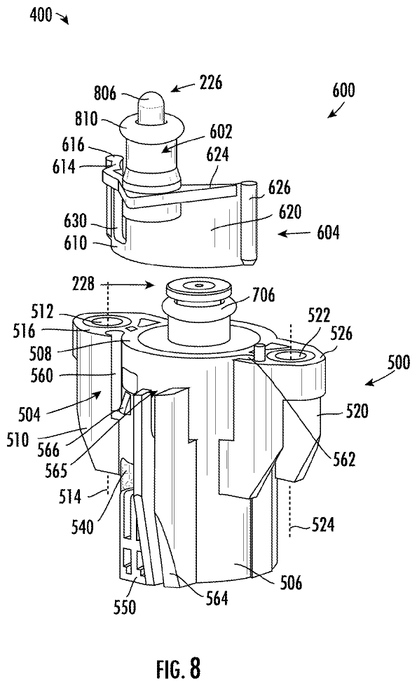

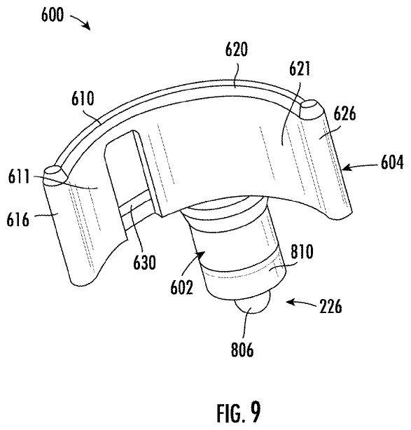

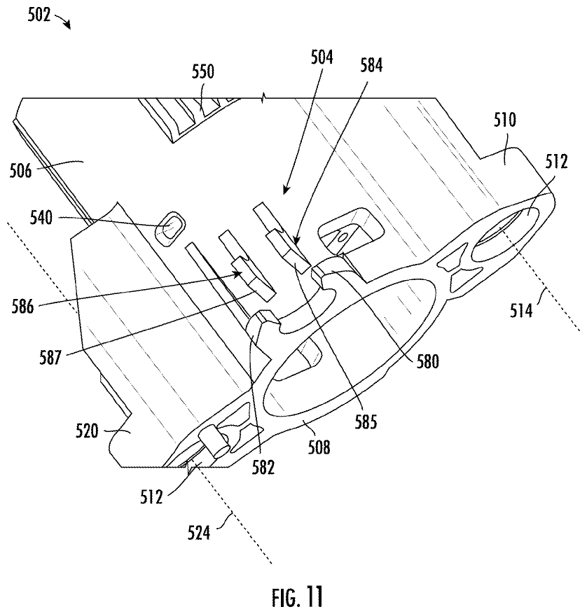

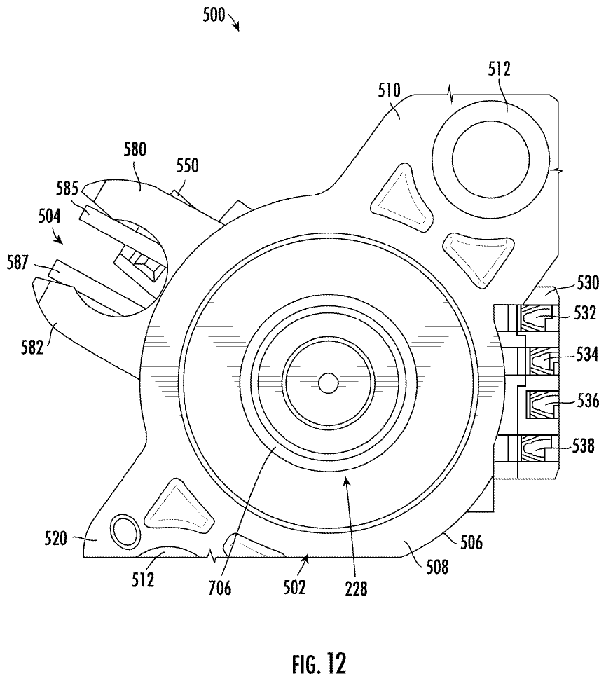

FIGS. 5-12 illustrate the sensor assembly 400 according to various embodiments. The pressure sensor housing 502 includes a first attachment portion 504. The first attachment portion 504 is on an outside of the pressure sensor housing 502. The first attachment portion 504 is configured to permit the pressure sensor housing 502 to attach to the temperature sensor housing 602. The temperature sensor housing 602 also includes a second attachment portion 604. The second attachment portion 604 is on an outside of the temperature sensor housing 602. The second attachment portion 604 is configured to be selectively coupled to the first attachment portion 504, such that the temperature sensor housing 602 is selectively attachable to and detachable from the pressure sensor housing 502 by attaching (e.g., coupling, etc.) the second attachment portion 604 of the temperature sensor housing 602 to the first attachment portion 504 of the pressure sensor housing 502.

The pressure sensor housing 502 includes an outer surface 506. In various embodiments, the outer surface 506 of the pressure sensor housing 502 has a cylindrical shape. In other embodiments, the outer surface 506 of the pressure sensor housing 502 has a non-cylindrical shape (e.g., rectangular, trapezoidal, etc.). The pressure sensor housing 502 includes a first support body 510. The first support body 510 extends outwardly from the outer surface 506 of the pressure sensor housing 502. The first support body 510 includes a first support bore 512. The doser housing 200 includes sensor assembly bores 330. The doser assembly 112 includes a first sensor assembly fastener 402 (e.g., screw, bolt, etc.) and a second sensor assembly fastener 403. The first sensor assembly fastener 402 couples the first support body 510 to the doser housing 200 via the first support bore 512 and one sensor assembly bore 330, thereby coupling the pressure sensor assembly 500 or the sensor assembly 400 (e.g., the pressure sensor assembly 500 and the temperature sensor assembly 600) to the doser housing 200. The first support bore 512 is centered along a first support bore axis 514.

The pressure sensor housing 502 also includes a second support body 520. The second support body 520 extends outwardly from the outer surface 506 of the pressure sensor housing 502. The second support body 520 includes a second support bore 522. The second sensor assembly fastener 403 couples the second support body 520 to the doser housing 200 via the second support bore 522 and one sensor assembly bore 330, thereby coupling the pressure sensor assembly 500 or the sensor assembly 400 to the doser housing 200. The second support bore 522 is centered along a second support bore axis 524.

In some embodiments, the first support body 510 and the second support body 520 are configured such that the first support bore axis 514 and the second support bore axis 524 are parallel. In other embodiments, the first support body 510 and the second support body 520 are configured such that the first support bore axis 514 and the second support bore axis 524 are not parallel.

The pressure sensor housing 502 further includes a lower surface 508 (e.g., bottom surface, etc.). The lower surface 508 of the pressure sensor housing 502 faces the doser housing 200 when the pressure sensor assembly 500 or the sensor assembly 400 is coupled to the doser housing 200. The first support body 510 further includes a lower surface 516. The lower surface 516 of the first support body 510 faces the doser housing 200 when the pressure sensor assembly 500 or the sensor assembly 400 is coupled to the doser housing 200. The second support body 520 further includes a lower surface 526. The lower surface 526 of the second support body 520 faces the doser housing 200 when the pressure sensor assembly 500 or the sensor assembly 400 is coupled to the doser housing 200.

In some embodiments, the pressure sensor housing 502, the first support body 510, and the second support body 520 are configured such that the lower surface 508 of the pressure sensor housing 502, the lower surface 516 of the first support body 510, and the lower surface 526 of the second support body 520 are all coplanar. This allows for the first support body 510 and the second support body 520 to couple to the doser housing 200 when the top surface of the doser housing is flat (e.g., not inclined, etc.). In other embodiments, the pressure sensor housing 502, the first support body 510, and the second support body 520 are configured such that only the lower surface 508 of the pressure sensor housing 502 and the lower surface 516 of the first support body 510 are coplanar (e.g., the lower surface 526 of the second support body 520 is on a different plane from the lower surface 508 of the pressure sensor housing 502 and the lower surface 516 of the first support body 510). This allows for the second support body 520 to couple to the doser housing 200 when a portion of the top surface of the doser housing 200 is not flat (e.g., inclined, includes a step, etc.). In other embodiments, the pressure sensor housing 502, the first support body 510, and the second support body 520 are configured such that the lower surface 508 of the pressure sensor housing 502, the lower surface 516 of the first support body 510, and the lower surface 526 of the second support body 520 are all on different planes. This allows for the first support body 510 and the second support body 520 to couple to the doser housing 200 when the top surface of the doser housing 200 is not flat.

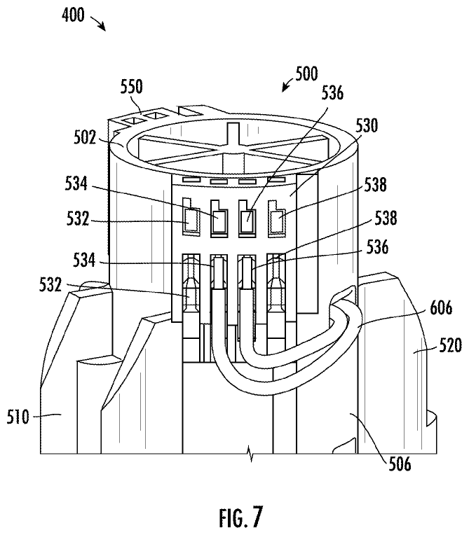

As illustrated in FIG. 7, the pressure sensor housing 502 further includes a first electrical connector 530. The first electrical connector 530 is coupled to the outer surface 506 of the pressure sensor housing 502. The first electrical connector 530 is configured to create electrical connections between the pressure sensor 228, the temperature sensor 226, and the sensor connectors 312. The first electrical connector 530 includes a first contact 532 (e.g., channel, lead, etc.). In some embodiments, the first contact 532 provides an electrical signal from the pressure sensor 228. The electrical signal from the pressure sensor 228 is received by the reductant delivery system controller 128 via the electrical customer interface 320. The reductant delivery system controller 128 determines a pressure measurement of the pressure sensor 228 based on the electrical signal from the pressure sensor 228. For example, the reductant delivery system controller 128 may determine the pressure measurement of the pressure sensor 228 based on at least one of a voltage of the electrical signal from the pressure sensor 228, a current of the electrical signal from the pressure sensor 228, or an impedance of the electrical signal from the pressure sensor 228.

The first electrical connector 530 also includes a second contact 534. In some embodiments, the second contact 534 provides a ground for the pressure sensor 228 and the temperature sensor 226. The first electrical connector also includes a third contact 536. In some embodiments, the third contact 536 provides an electrical signal from the temperature sensor 226. The electrical signal from the temperature sensor 226 is received by the reductant delivery system controller 128 via the electrical customer interface 320. The reductant delivery system controller 128 determines a temperature measurement of the temperature sensor 226 based on the electrical signal from the temperature sensor 226. For example, the reductant delivery system controller 128 may determine the temperature measurement of the temperature sensor 226 based on at least one of a voltage of the electrical signal from the temperature sensor 226, a current of the electrical signal from the temperature sensor 226, or an impedance of the electrical signal from the temperature sensor 226.

The first electrical connector includes a fourth contact 538. In some embodiments, the fourth contact 538 is configured as an electrical supply. As is explained in more detail herein, the fourth contact 538 provides an electrical connection which provides electrical supply from the reductant delivery system controller 128, via the electrical customer interface 320, to the temperature sensor 226 and the pressure sensor 228.

The pressure sensor housing 502 includes a pathway 540. The pathway 540 extends inwardly from the outer surface 506 of the pressure sensor housing 502 therethrough. The pathway 540 facilitates passage of electronic connectors (e.g., electrical wires, etc.) through the pressure sensor housing 502. The temperature sensor assembly 600 includes one or more electrical wires 606. The electrical wires 606 of the temperature sensor assembly 600 are coupled to the temperature sensor 226. In some embodiments, the electrical wires 606 of the temperature sensor assembly 600 are configured to pass through the pathway 540 and couple to the second contact 534 and the third contact 536.

The pressure sensor housing 502 further includes a second electrical connector 550. The second electrical connector 550 is coupled to the outer surface 506 of the pressure sensor housing 502. The second electrical connector 550 is configured to create electrical connections between the heater 272 and the heater connectors 316. The second electrical connector 550 includes contacts 552. The heater 272 includes electrical wires 274. The electrical wires 274 of the heater 272 are used to provide electrical power to the heater 272. The electrical wires 274 of the heater 272 are configured to couple with contacts 552. In some embodiments, one contact 552 is configured as electrical supply to the heater 272. This contact 552 provides an electrical connection which provides electrical supply from the reductant delivery system controller 128, via the electrical customer interface 320, to the heater 272 such that the reductant delivery system controller 128 determines an amount of heat the heater 272 emits. In this embodiment, the other contact 552 is configured as ground for the heater 272.

In an embodiment illustrated in FIGS. 5, 6, 8, and 9, the first attachment portion 504 includes a first groove 560. The first groove 560 is coupled to the first support body 510. The temperature sensor housing 602 includes a first arm 610. The first arm 610 extends outwardly from the temperature sensor housing 602. The second attachment portion 604 includes a first tab 616. The first tab 616 of the second attachment portion 604 is disposed on a terminating end of the first arm 610. The first tab 616 of the second attachment portion 604 is configured to be slidably located in the first groove 560. The first arm 610 includes an inner surface 611. The inner surface 611 of the first arm 610 faces the outer surface 506 of the pressure sensor housing 502 when the first tab 616 of the second attachment portion 604 is received within the first groove 560. The first arm 610 includes a lower surface 614. The lower surface 614 of the first arm 610 faces the doser housing 200 when the sensor assembly 400 is coupled to the doser housing 200.

In the embodiment illustrated in FIGS. 5, 6, 8, and 9, the first attachment portion 504 also includes a second groove 562. The second groove 562 is coupled to the second support body 520. The temperature sensor housing 602 includes a second arm 620. The second arm extends outwardly from the temperature sensor housing 602. The second attachment portion 604 includes a second tab 626. The second tab 626 of the second attachment portion 604 is disposed on a terminating end of the second arm 620. The second tab 626 of the second attachment portion 604 is configured to be slidably located in the second groove 562. The second arm 620 includes an inner surface 621. The inner surface 621 of the second arm 620 faces the outer surface 506 of the pressure sensor housing 502 when the second tab 626 of the second attachment portion 604 is received within the second groove 562. The second arm 620 includes a lower surface 624. The lower surface 624 of the second arm 620 faces the doser housing 200 when the sensor assembly 400 is coupled to the doser housing 200.

In some embodiments, the first attachment portion 504 is considered to be attached (e.g., coupled, engaged, etc.) to the second attachment portion 604 when (i) the first tab 616 of the second attachment portion 604 is received within the first groove 560 or (ii) the second tab 626 of the second attachment portion 604 is received within the second groove 562.

In some embodiments, when the first attachment portion 504 is attached to the second attachment portion 604, a void (e.g., gap, spacing, etc.) is formed at least one of: (i) between the inner surface 611 of the first arm 610 and the outer surface 506 of the pressure sensor housing 502, or (ii) between the inner surface 621 of the second arm 620 and the outer surface 506 of the pressure sensor housing 502. The void provides a positional tolerance (e.g., manufacturing tolerance, etc.) for the temperature sensor assembly 600 within the sensor assembly 400, such that the temperature sensor 226 is capable of translating along a plane that is parallel to the lower surface 508 of the pressure sensor housing 502. The positional tolerance allows the temperature sensor 226 to remain fixed relative to the temperature sensor chamber 222 despite translation of the temperature sensor assembly 600 relative to the doser housing 200 when the sensor assembly 400 is coupled to the doser housing 200. Therefore, the positional tolerance reduces a risk of fluid exiting the doser housing 200 through the temperature sensor chamber 222 during translation of the temperature sensor 226 within the temperature sensor chamber 222.

In some embodiments, when the first attachment portion 504 is attached to the second attachment portion 604, the pressure sensor housing 502, the first support body 510, the second support body 520, the first arm 610, and the second arm 620 are configured such that the lower surface 508 of the pressure sensor housing 502, the lower surface 516 of the first support body 510, the lower surface 526 of the second support body 520, the lower surface 614 of the first arm 610, and the lower surface 624 of the second arm 620 are all coplanar. This allows for the first support body 510 and the second support body 520 to couple to the doser housing 200 when the top surface of the doser housing 200 is flat.

In other embodiments, when the first attachment portion 504 is attached to the second attachment portion 604, the pressure sensor housing 502, the first support body 510, the second support body 520, the first arm 610, and the second arm 620 are configured such that only the lower surface 508 of the pressure sensor housing 502, the lower surface 516 of the first support body 510, the lower surface 614 of the first arm 610, and the lower surface 624 of the second arm 620 are all coplanar (e.g., the lower surface 526 of the second support body 520 is on a different plane from the lower surface 508 of the pressure sensor housing 502, the lower surface 516 of the first support body 510, the lower surface 614 of the first arm 610, and the lower surface 624 of the second arm 620). This allows for the second support body 520 to couple to the doser housing 200 when a portion of the top surface of the doser housing 200 is not flat.

In other embodiments, when the first attachment portion 504 is attached to the second attachment portion 604, the pressure sensor housing 502, the first support body 510, the second support body 520, the first arm 610, and the second arm 620 are configured such that the lower surface 508 of the pressure sensor housing 502, the lower surface 516 of the first support body 510, the lower surface 526 of the second support body 520, the lower surface 614 of the first arm 610, and the lower surface 624 of the second arm 620 are all on different planes. This allows for the first support body 510 and the second support body 520 to couple to the doser housing 200 when the top surface of the doser housing 200 is not flat.

In some embodiments, the inner surface 611 of the first arm 610 has a first arm radius of curvature, the inner surface 621 of the second arm 620 has a second arm radius of curvature, and the outer surface 506 of the pressure sensor housing 502 has a pressure sensor housing radius of curvature. The pressure sensor housing 502, the first arm 610, and the second arm 620 are configured such that (i) the first arm radius of curvature is between 95% of the pressure sensor housing radius of curvature and 105% of the pressure sensor housing radius of curvature, inclusive, and (ii) the second arm radius of curvature is between 95% of the pressure sensor housing radius of curvature and 105% of the pressure sensor housing radius of curvature, inclusive.

In the embodiment illustrated in FIGS. 5, 6, 8, and 9, the pressure sensor housing 502 further includes pins 564. The pins 564 extend outwardly from the outer surface 506 of the pressure sensor housing 502. The pins 564 are configured such that a gap 565 is formed between at least one pin 564 and the outer surface 506 of the pressure sensor housing 502. The pressure sensor housing 502 and the temperature sensor housing 602 are configured such that a portion of the temperature sensor housing 602 is received within the gap 565 when the first attachment portion 504 is attached to the second attachment portion 604. The pins 564 are configured to secure (e.g., grip, hold in place, etc.) the temperature sensor housing 602 to the pressure sensor housing 502 when the first attachment portion 504 is attached to the second attachment portion 604. In some embodiments, the pressure sensor housing 502 includes two pins 564. In other embodiments, the pressure sensor housing 502 includes one pin 564 or more than two pins 564 (e.g., three pins 564, five pins 564, etc.). In other embodiments, the pressure sensor housing 502 does not include the pins 564. In these embodiments, when the first attachment portion 504 is attached to the second attachment portion 604, the temperature sensor housing 602 secures to the pressure sensor housing 502 via (i) the first tab 616 of the second attachment portion 604 received within the first groove 560 and/or (ii) the second tab 626 of the second attachment portion 604 received within the second groove 562.

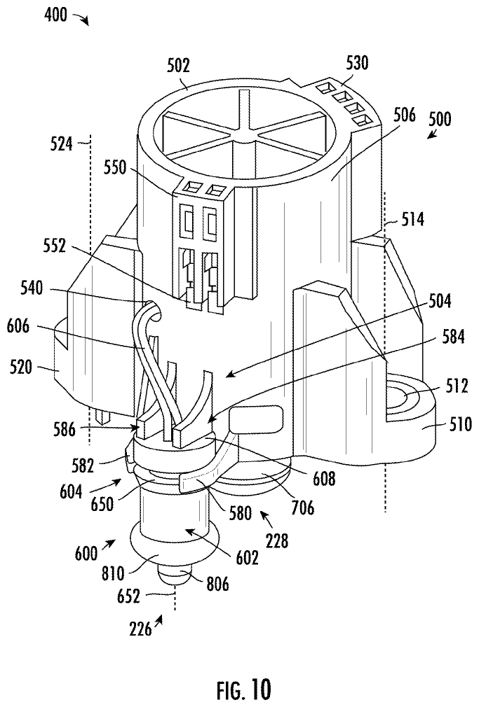

In the embodiment illustrated in FIGS. 5, 6, 8, and 9, the second attachment portion 604 further includes an attachment aperture 630. The attachment aperture 630 extends inwardly therethrough the inner surface 611 of the first arm 610. The first attachment portion 504 further includes a first attachment portion tab 566. The first attachment portion tab 566 extends outwardly from the outer surface 506 of the pressure sensor housing 502. The first attachment portion tab 566 is configured to be located in the attachment aperture 630 when the first attachment portion 504 is attached to the second attachment portion 604. The sensor assemblies 400 of FIGS. 10-12 are considered to be the same as the sensor assemblies 400 of FIGS. 5-9, except as otherwise described.

In another embodiment illustrated in FIG. 10, the first attachment portion 504 includes a first tab 580. The first tab 580 of the first attachment portion 504 extends outwardly from the outer surface 506 of the pressure sensor housing 502. The first attachment portion 504 includes a second tab 582. The second tab 582 of the first attachment portion 504 extends outwardly from the outer surface 506 of the pressure sensor housing 502. The first attachment portion includes a first bracket 584. The first bracket 584 extends outwardly from the outer surface 506 of the pressure sensor housing 502. The first bracket 584 includes a lower surface 585. The first attachment portion 504 includes a second bracket 586. The second bracket 586 extends outwardly from the outer surface 506 of the pressure sensor housing 502. The second bracket 586 includes a lower surface 587.

In the embodiment illustrated in FIG. 10, the temperature sensor housing 602 includes a temperature sensor housing axis 652. The temperature sensor 226 and the temperature sensor housing 602 are centered along the temperature sensor housing axis 652. The second attachment portion 604 includes a center groove 650. The center groove 650 is centered along the temperature sensor housing axis 652. The center groove 650 is configured to receive (i) the first tab 580 of the first attachment portion 504 and (ii) the second tab 582 of the first attachment portion 504, thereby attaching (e.g., coupling, engaging, etc.) the first attachment portion 504 to the second attachment portion 604. The temperature sensor housing 602 is configured to be received by the first bracket 584 and the second bracket 586 when the center groove 650 receives (i) the first tab 580 of the first attachment portion 504 or (ii) the second tab 582 of the first attachment portion 504.

In the embodiment illustrated in FIG. 10, the temperature sensor housing 602 further includes an upper surface 608. The upper surface 608 of the temperature sensor housing 602 faces the lower surface 585 of the first bracket 584 and the lower surface 587 of the second bracket 586 when the center groove 650 receives (i) the first tab 580 of the first attachment portion 504 or (ii) the second tab 582 of the first attachment portion 504. In other embodiments, the first attachment portion 504 includes only one of the first tab 580 and the second tab 582 and only one bracket of the first bracket 584 and the second bracket 586. In other embodiments, the first attachment portion 504 includes a plurality of first tabs 580 (e.g., two first tabs 580, three first tabs 580, etc.) and a plurality of second tabs 582 (e.g., two second tabs 582, three second tabs 582, etc.) and the second attachment portion 604 includes a plurality of center grooves 650 that are configured to receive (i) the plurality of first tabs 580 of the first attachment portion 504 and (ii) the plurality of second tabs 582 of the first attachment portion 504.

### V. Overview of Example Sensors

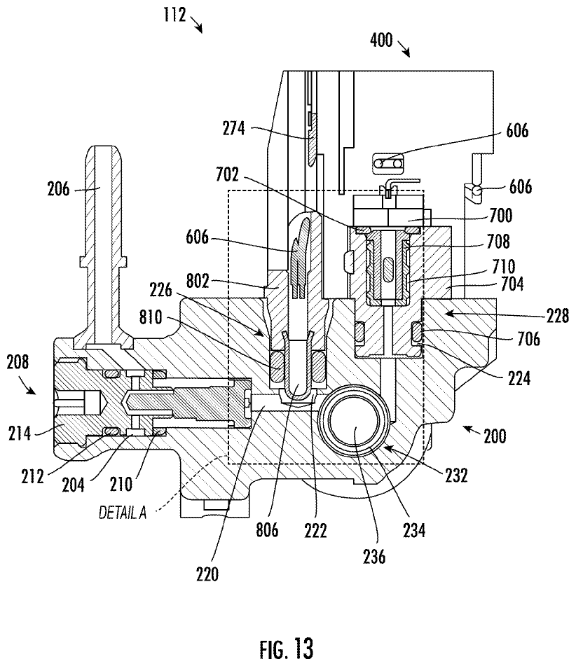

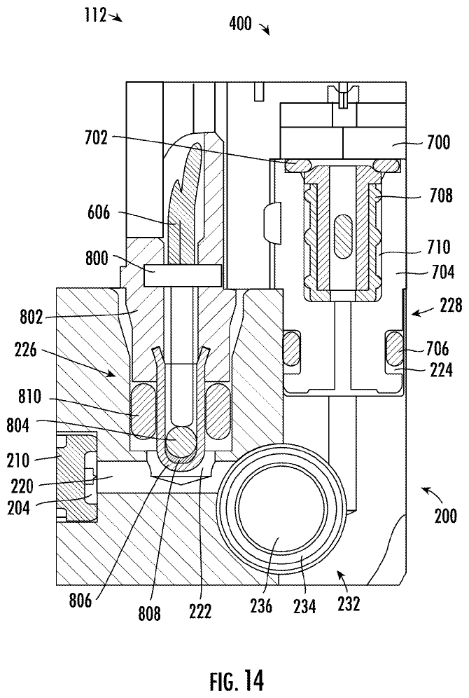

In an embodiment illustrated in FIGS. 13 and 14, the pressure sensor 228 includes a measurement cell 700. The measurement cell 700 is coupled to an upper portion of the pressure sensor 228. The measurement cell 700 obtains a pressure reading (e.g., measurement, etc.) from the pressure sensor 228 and transmits the pressure reading to the reductant delivery system controller 128 via the electrical customer interface 320. The pressure sensor 228 includes a first sealing ring 702. The first sealing ring 702 is coupled to a lower portion of the measurement cell 700. The first sealing ring 702 seals the measurement cell 700 from other components within the pressure sensor 228. The pressure sensor 228 includes a pressure sensor casing 704. The pressure sensor casing 704 contains some components of the pressure sensor 228. In some embodiments, the pressure sensor casing 704 is made out of (e.g., manufactured from, etc.) plastic. In other embodiments, the pressure sensor casing 704 is made out of metal.

The pressure sensor 228 further includes a second sealing ring 706. The second sealing ring 706 is coupled to an outside of the pressure sensor casing 704. The second sealing ring 706 creates a seal between the pressure sensor 228 and the pressure sensor chamber 224 to minimize or prevent transmission (e.g., leakage, etc.) of fluid to the outside of the doser housing 200. In other embodiments, the pressure sensor 228 does not include the second sealing ring 706, such that the pressure sensor casing 704 creates a seal between the pressure sensor 228 and the pressure sensor chamber 224.

The pressure sensor 228 further includes a pressure sensor frost compensation membrane 708. The pressure sensor frost compensation membrane 708 is coupled to an inside of the pressure sensor casing 704. The pressure sensor frost compensation membrane 708 compensates for an expansion of the fluid near the pressure sensor 228. This prevents the fluid from damaging the pressure sensor 228 and components of the pressure sensor 228 when it expands. The pressure sensor 228 includes an air gap 710. The air gap 710 is coupled between the pressure sensor frost compensation membrane 708 and the pressure sensor casing 704. The air gap 710 provides a compressible space for the pressure sensor frost compensation membrane 708 and the pressure sensor casing 704 when the pressure sensor 228 undergoes various pressures and temperatures that can cause the pressure sensor frost compensation membrane 708 and/or the pressure sensor casing 704 to expand and contract.

In an embodiment illustrated in FIGS. 13 and 14, the temperature sensor 226 includes a printed circuit board (PCB) 800. The PCB 800 is coupled to an upper portion of the temperature sensor 226. The PCB 800 is also coupled to the electrical wires 606 of the temperature sensor assembly 600. The PCB 800 obtains a temperature reading (e.g., measurement, etc.) from the temperature sensor 226 and transmits the temperature reading to the reductant delivery system controller 128 via the electrical customer interface 320. The temperature sensor 226 includes a temperature sensor casing 802. The temperature sensor casing 802 houses some components of the temperature sensor 226. In some embodiments, the temperature sensor casing 802 is made out of plastic. In other embodiments, the temperature sensor casing 802 is made out of metal.

In some embodiments, the temperature sensor 226 further includes a negative temperature coefficient (NTC) compound 804. The NTC compound 804 is coupled to the PCB 800. The NTC compound 804 is a temperature sensing element that allows the temperature sensor 226 to facilitate measurement of temperature in a particular volume of space. In other embodiments, the temperature sensor 226 further includes a semiconductor component. The semiconductor component is coupled to the PCB 800. The semiconductor component is a temperature sensing element that allows the temperature sensor 226 to facilitate measurement of temperature in a particular volume of space. The semiconductor component may include two identical diodes. In yet other embodiments, the temperature sensor 226 includes a thermocouple as a temperature sensing element that allows the temperature sensor 226 to facilitate measurement of temperature in a particular volume of space.

The temperature sensor 226 includes a sleeve 806. The sleeve 806 is coupled to the temperature sensor casing 802. In some embodiments, the sleeve 806 is also coupled to the NTC compound 804. In other embodiments, the sleeve 806 is also coupled to the semiconductor component.

The sleeve 806 is configured to protect the NTC compound 804 or the semiconductor component from the fluid inside of the doser housing 200, create a seal for the temperature sensor casing 802, and conduct heat. In some embodiments, the sleeve 806 is made out stainless steel (e.g., a metal). In other embodiments, the sleeve 806 is made out of other types of metals (e.g., aluminum, copper, etc.).

The temperature sensor 226 further includes a heat transfer compound 808 (e.g., thermal paste, etc.). The heat transfer compound 808 is coupled to an inside of the sleeve 806. The heat transfer compound 808 is configured to help (e.g., assist, improve efforts of, etc.) the sleeve 806 in conducting heat. The temperature sensor 226 includes a sealing ring 810. The sealing ring 810 is coupled to an outside of the sleeve 806. The sealing ring 810 (i) protects the sleeve 806 from making contact with an inside wall of the temperature sensor chamber 222 and (ii) creates a seal between the temperature sensor 226 and the temperature sensor chamber 222 to minimize or prevent transmission of fluid to the outside of the doser housing 200. In other embodiments, the temperature sensor 226 does not include the sealing ring 810, such that the temperature sensor casing 802 creates a seal between the temperature sensor 226 and the temperature sensor chamber 222.

### VI. Configuration of Example Embodiments

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “substantially,” “generally,” “approximately,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The terms “fluidly coupled to” and the like, as used herein, mean the two components or objects have a pathway formed between the two components or objects in which a fluid, such as air, reductant, an air-reductant mixture, exhaust gas, hydrocarbon, an air-hydrocarbon mixture, may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, the use of ranges of values (e.g., W1 to W2, etc.) herein are inclusive of their maximum values and minimum values (e.g., W1 to W2 includes W1 and includes W2, etc.), unless otherwise indicated. Furthermore, a range of values (e.g., W1 to W2, etc.) does not necessarily require the inclusion of intermediate values within the range of values (e.g., W1 to W2 can include only W1 and W2, etc.), unless otherwise indicated.

1. A doser assembly comprising:
a doser housing comprising:
a reductant inlet passage, and
a reductant return passage;
a doser located at least partially within the doser housing; and
a sensor assembly comprising:
a pressure sensor assembly comprising a pressure sensor, and
a temperature sensor assembly comprising a temperature sensor;
wherein either (i) the pressure sensor and the temperature sensor are located at least partially within the reductant inlet passage, or (ii) the pressure sensor and the temperature sensor are located at least partially within in the reductant return passage.

2. The doser assembly of claim 1, wherein the pressure sensor and the temperature sensor are located at least partially within the reductant inlet passage.

3. The doser assembly of claim 1, wherein the pressure sensor and the temperature sensor are located at least partially within the reductant return passage.

4. The doser assembly of claim 3, wherein the doser housing further comprises a doser chamber, the doser chamber being fluidly coupled to the reductant return passage and partially receiving the doser.

5. The doser assembly of claim 1, wherein:
the doser housing further comprises a filter chamber, the filter chamber being fluidly coupled to the reductant inlet passage; and
the doser assembly further comprises a doser filter, the doser filter is at least partially located in the filter chamber such that the doser filter is configured to filtering a fluid passing through the filter chamber.

6. The doser assembly of claim 1, wherein:
the doser housing further comprises a frost compensation chamber fluidly coupled to the reductant inlet passage; and
the doser assembly further comprises a frost compensator at least partially located in the frost compensation chamber, the frost compensator comprising a foam insert, the foam insert configured to allow passage of a reductant within the frost compensation chamber and to be compressed by expansion of the reductant within the frost compensation chamber.

7. The doser assembly of claim 1, wherein:
the doser housing further comprises a heater chamber; and
the doser assembly further comprises a heater located in the heater chamber and configured to increase temperature of a reductant within the doser housing.

8. A sensor assembly comprising:
a pressure sensor assembly comprising:
a pressure sensor housing comprising a first attachment portion, and
a pressure sensor at least partially located in the pressure sensor housing; and
a temperature sensor assembly comprising:
a temperature sensor housing comprising a second attachment portion, and
a temperature sensor at least partially located in the temperature sensor housing;
wherein the temperature sensor housing is selectively attachable to and detachable from the pressure sensor housing by attaching the second attachment portion to the first attachment portion.

9. The sensor assembly of claim 8, wherein:
the pressure sensor housing further comprises an outer surface;
the first attachment portion comprising:
a first tab extending outwardly from the outer surface of the pressure sensor housing,
a second tab extending outwardly from the outer surface of the pressure sensor housing,
a first bracket extending outwardly from the outer surface of the pressure sensor housing, the first bracket comprises a lower surface, and
a second bracket extending outwardly from the outer surface of the pressure sensor housing, the second bracket comprises a lower surface;
the second attachment portion comprising:
a center groove centered along a temperature sensor housing axis, the center groove configured to receive the first tab of the first attachment portion and the second tab of the first attachment portion; and
the temperature sensor housing further comprises an upper surface, wherein the temperature sensor housing is configured to be received by the first bracket and the second bracket such that, when the center groove receives (i) the first tab of the first attachment portion or (ii) the second tab of the first attachment portion, the upper surface of the temperature sensor housing faces the lower surface of the first bracket and the upper surface of the temperature sensor housing faces the lower surface of the second bracket.

10. The sensor assembly of claim 8, wherein:
the pressure sensor housing further comprises:
an outer surface,
a first support body extending outwardly from the outer surface of the pressure sensor housing, and
a second support body extending outwardly from the outer surface of the pressure sensor housing;
the first attachment portion comprises:
a first groove coupled to the first support body, and
a second groove coupled to the second support body;
the temperature sensor housing further comprises:
a first arm extending outwardly from the temperature sensor housing, the first arm comprises an inner surface, and
a second arm extending outwardly from the temperature sensor housing, the second arm comprises an inner surface; and
the second attachment portion comprises:
a first tab disposed on a terminating end of the first arm configured to be slidably located in the first groove such that, when the first tab of the second attachment portion is received within the first groove, the inner surface of the first arm faces the outer surface of the pressure sensor housing, and
a second tab disposed on a terminating end of the second arm configured to be slidably located in the second groove such that, when the second tab of the second attachment portion is received within the second groove, the inner surface of the second arm faces the outer surface of the pressure sensor housing.

11. The sensor assembly of claim 10, wherein:
the pressure sensor housing further comprises a lower surface;
the first support body further comprises a lower surface; and
the lower surface of the pressure sensor housing and the lower surface of the first support body are coplanar.

12. The sensor assembly of claim 11, wherein:
the first arm further comprises a lower surface;
the second arm further comprises a lower surface; and
the pressure sensor housing, the first support body, the first arm, and the second arm are configured such that, when the first tab of the second attachment portion is received within the first groove, the lower surface of the pressure sensor housing, the lower surface of the first support body, the lower surface of the first arm, and the lower surface of the second arm are coplanar.

13. The sensor assembly of claim 10, wherein:
the first support body further comprises a first support bore that is configured to receive a first sensor assembly fastener, the first support bore centered along a first support bore axis;
the second support body further comprises a second support bore that is configured to receive a second sensor assembly fastener, the second support bore centered along a second support bore axis; and
the first support bore axis and the second support bore axis are parallel.

14. The sensor assembly of claim 10, wherein the pressure sensor housing further comprises a first electrical connector coupled to the outer surface of the pressure sensor housing.

15. The sensor assembly of claim 10, wherein:
the inner surface of the first arm has a first arm radius of curvature;
the inner surface of the second arm has a second arm radius of curvature;
the outer surface of the pressure sensor housing has a pressure sensor housing radius of curvature;
the first arm radius of curvature is between 95% of the pressure sensor housing radius of curvature and 105% of the pressure sensor housing radius of curvature, inclusive; and
the second arm radius of curvature is between 95% of the pressure sensor housing radius of curvature and 105% of the pressure sensor housing radius of curvature, inclusive.

16. The sensor assembly of claim 10, wherein:
the pressure sensor housing further comprises at least one pin extending outwardly from the outer surface of the pressure sensor housing such that a gap is formed between the at least one pin and the outer surface of the pressure sensor housing; and
the temperature sensor housing and the pressure sensor housing are configured such that a portion of the temperature sensor housing is received within the gap when (i) the first tab of the second attachment portion is received within the first groove or (ii) the second tab of the second attachment portion is received within the second groove.

17. The sensor assembly of claim 10, wherein:
the second attachment portion further comprises an attachment aperture extending inwardly therethrough the inner surface of the first arm; and
the first attachment portion further comprises a first attachment portion tab extending outwardly from the outer surface of the pressure sensor housing and configured to be located in the attachment aperture when (i) the first tab of the second attachment portion is received within the first groove or (ii) the second tab of the second attachment portion is received within the second groove.

18. A doser assembly comprising:
a doser housing;
a doser located at least partially within the doser housing; and
a sensor assembly comprising:
a pressure sensor assembly comprising:
a pressure sensor housing comprising a first attachment portion, and
a pressure sensor at least partially located in the pressure sensor housing; and
a temperature sensor assembly comprising:
a temperature sensor housing comprising a second attachment portion, and
a temperature sensor at least partially located in the temperature sensor housing;
wherein the temperature sensor housing is selectively attachable to and detachable from the pressure sensor housing by attaching the second attachment portion to the first attachment portion.

19. A system comprising:
a reductant pump configured to pressurize reductant; and
the doser assembly of claim 18,
wherein the doser housing comprises:
a doser chamber, the doser located at least partially within the doser chamber,
a reductant inlet passage disposed upstream of the doser chamber, the reductant inlet passage configured to receive the reductant from the reductant pump and provide the reductant to the doser chamber, and
a reductant return passage disposed downstream of the doser chamber, the reductant return passage configured to receive at least a portion of the reductant from the doser chamber and provide the at least the portion of the reductant to the reductant pump; and
wherein the pressure sensor and the temperature sensor are located at least partially within the reductant inlet passage.

20. A system comprising:
a reductant pump configured to pressurize reductant; and
the doser assembly of claim 18,
wherein the doser housing comprises:
a doser chamber, the doser located at least partially within the doser chamber,
a reductant inlet passage disposed upstream of the doser chamber, the reductant inlet passage configured to receive the reductant from the reductant pump and provide the reductant to the doser chamber, and
a reductant return passage disposed downstream of the doser chamber, the reductant return passage configured to receive at least a portion of the reductant from the doser chamber and provide the at least the portion of the reductant to the reductant pump; and
wherein the pressure sensor and the temperature sensor are located at least partially within the reductant return passage.
